(19) United States
(12) Patent Application Publication
(10) Pub. No.: US 2008/0050997 A1
(43) Pub. Date: Feb. 28, 2008

(54) Method for Machining a Lamp and Machined by Said Method

(75) Inventors: Andreas Nittke, Bergheim (DE); Georg Rosenbauer, Wassertrudingen (DE)

Correspondence Address: OSRAM SYLVANIA INC, 100 ENDICOTT STREET, DANVERS, MA, 01923, US

(73) Assignee: Patent-Treuhand-Gesellschaft Fur Elektrische Gluhlampen MBH, Munich (DE)

(21) Appl. No.: 11/628,157

(22) PCT Filed: May 19, 2005
(86) PCT No.: PCT/DE05/00922

§ 371 Date: Nov. 30, 2006

(30) Foreign Application Priority Data
Jun. 9, 2004 (DE) 10 2004 028 004.5

(51) Int. Cl. H01J 9/26

(52) U.S. Cl. 445/44

(57) ABSTRACT

Method for machining a lamp and a lamp machined by the method, including a lamp bulb, in which an incandescent element with power supply is housed and which defines a chamber for a filling gas which is tightly sealed by a compression seal. According to the invention, after filling, a part of the lamp bulb is heated by introduction of heat, preferably by laser and moulded or refused in order to alter the outer contour of the lamp bulb or tempered.

### TECHNICAL FIELD

The invention relates to a method for processing a lamp in accordance with the preamble of claim 1 and a lamp processed in accordance with such a method.

In principle, the invention can be applied to all lamps in which a luminous means, for example an incandescent filament of an incandescent lamp or an electrode for generating a discharge arc of a discharge lamp is accommodated in a lamp bulb or the like. The main application area, however, would have to be halogen lamps, in particular halogen incandescent lamps or discharge lamps, in the case of which the filling gas contains a proportion of halogens. Such a halogen incandescent lamp and its production methods are explained, for example, in DE 196 23 499 A1. Specific exemplary embodiments of these halogen incandescent lamps in low-volt or high-volt embodiments can be found at www.osram.de/produkte/allgemein/halogen/ubersicht.html.

The production of these known halogen incandescent lamps generally takes place by initially a tubular bulb being provided first at the front end with a rounded dome, on which an axially protruding exhaust tube attachment is formed. A frame with a filament and power supply lines is then inserted through the open supply opening of the bulb. The lamp bulb is closed in a gas-tight manner in the region of the supply opening by means of a pinch seal, and the interior of the lamp bulb is rinsed, evacuated and filled with filling gas via an exhaust tube, which is fused onto the exhaust tube attachment. Finally, the exhaust tube is fused off—the lamp bulb is closed in a gas-tight manner.

In the case in which diffuse illumination is desired, the surface of the lamp bulb can be provided with a matt finish by means of sandblasting, liquid-acid etching, sol gel coating with SiO₂ as scattering centers or the like. This matt-finishing entails a loss in luminous flux, however. If an anti-dazzle effect is desired without a loss in luminous flux or effect lighting is desired with a light/dark effect, an additionally faceted enveloping bulb can be placed onto the lamp bulb. This fitting of the enveloping bulb requires additional complexity in terms of apparatus.

In particular in the case of lamp manufacturers, it is often necessary to compare the luminous flux of matt-finished lamps with that of clear lamps without a matt finish. This is particularly difficult when there is no lamp without a matt finish available—in this case the matt finish needs to be removed by a complex polishing method in order to detect the luminous flux through a clear lamp bulb.

### DESCRIPTION OF THE INVENTION

It is the object of the present invention to provide a method for processing a lamp and to provide a lamp processed in accordance with such a method, in the case of which method and lamp changes to the surface structure or contour or the internal glass stresses can be carried out with little complexity in terms of apparatus.

This object is achieved—as regards the method by the combination of features in patent claim 1 and as regards the lamp by the combination of features in coordinate patent claim 7.

Particularly advantageous refinements of the inventions can be gleaned from the dependent claims.

According to the invention, the lamp is initially manufactured in the conventional manner, with the result that the filling gas is enclosed in a gas-tight manner in the lamp bulb. Once the luminous means has been inserted and filling has been carried out, according to the invention the lamp bulb is heated to a deformation temperature and is then deformed by suitable tools, or surface regions are melted or material is removed from a surface region of the lamp bulb in order to form a specific surface structure or glass structure, for example in order to eliminate a matt finish by means of remelting or removal or to produce a matt finish by removing material on the surface of the lamp bulb or, in the case of soft glass, to produce small cracks in the glass which are used as scattering centers.

In addition, the glass, in particular hard glass, can be tempered by means of a subsequent laser treatment. As a result, the heat treatment of the complete lamp in a tempering furnace for the purpose of reducing the internal mechanical stresses in the glass can be dispensed with, and there is no risk of oxidation of base parts or power supply lines in the tempering furnace. During the heat treatment by means of lasers, only the glass of the lamp bulb, for example from the pinch-seal edge up to the exhaust nipple, is tempered, i.e. is subjected to the heat treatment. Power supply lines and base parts remain cold, on the other hand. At the same time, microcracks on the surface of the lamp vessel can be removed which would otherwise result in weakening of the glass.

That is to say, the invention moves away from conventional methods in which deformation/melting takes place directly before or after filling of the lamp bulb—according to the invention, the lamp produced in accordance with the conventional method is merely to be seen as an intermediate product which is further processed in a further working step to give the finished product.

It is particularly preferable to carry out this heating by means of laser beam or another high-energy radiation. Subsequently subjecting a lamp to a laser beam is already known from DE 100 26 567 A1, but in this case the laser beam is merely used for writing which is applied to a metal fuse-in foil of a frame inserted into the lamp bulb. This writing therefore takes place through the lamp bulb, in which case the lamp bulb is neither fused nor subjected to another structural modification.

In one preferred exemplary embodiment, the laser beam is guided along a predetermined movement path such that either a surface layer is fused or removed areally and, for example, a matt finish can be removed or a predetermined surface pattern is formed by means of fusing or removal. However, with the aid of the laser beam it is also possible for a matt finish to be produced in a predetermined region-on the surface of the lamp vessel by identical cracks being produced by means of the laser beam in soft-glass bulbs, which cracks act as scattering centers. In the case of quartz glass, glass is evaporated from the surface and removed, for example by being sucked away. As a result, the surface is roughened, i.e. tiny, light-scattering cracks are produced on the surface.

In an alternative variant, the lamp bulb is heated to a deformation temperature and then final shaping of the lamp bulb is carried out by means of a tool, for example a cross section, which is approximately circular after filling, being deformed to give a larger circular or other (for example matched to the rotation of the lamp by corresponding driving of the shaping tools), for example elliptical cross section, which may be required in the case of lamps having an interference filter coating. The widened circular or elliptical cross section can likewise assume an elliptical or other non-cylindrical shape along the bulb axis, which shape is matched to the filament geometry.

The last-mentioned method step can be applied particularly advantageously to lamp designs in which the luminous means is a filament of an incandescent lamp which is fixed in position by means of pimples formed in the lamp bulb.

The surface pattern formed, for example, by means of a laser beam, can form facets, which run in the parallel direction with respect to the lamp axis or in a zigzag direction. As a result, effect lighting can be achieved in three dimensions (for example a striped illumination effect).

### BRIEF DESCRIPTION OF THE DRAWING

The invention will be explained in more detail below using an exemplary embodiment with reference to drawings, in which:

FIG. 1 shows a front view of a halogen incandescent lamp;

FIG. 2 shows a schematic illustration of an apparatus for carrying out the method;

FIG. 3 shows a halogen incandescent lamp having a lamp bulb with a matt finish, which halogen incandescent lamp is processed in accordance with the method according to the invention;

FIG. 4 shows a lamp bulb, in the case of which a zigzag facet is applied;

FIG. 5 shows a lamp bulb having parallel faceting;

FIG. 6 shows a lamp, whose lamp bulb has been deformed in accordance with the method according to the invention from a circular cross section into another cross section, and

FIG. 7 shows a lamp bulb consisting of glass (preferably soft glass), in the case of which a matt finish has been produced by means of a laser beam. Small cracks in this case act as scattering centers for the matt finish.

### PREFERRED EMBODIMENT OF THE INVENTION

The invention will be explained below using halogen incandescent lamps. As has already been mentioned at the outset, the invention can also be used in other lamp types, however, in which a luminous means is arranged within a lamp bulb or the like.

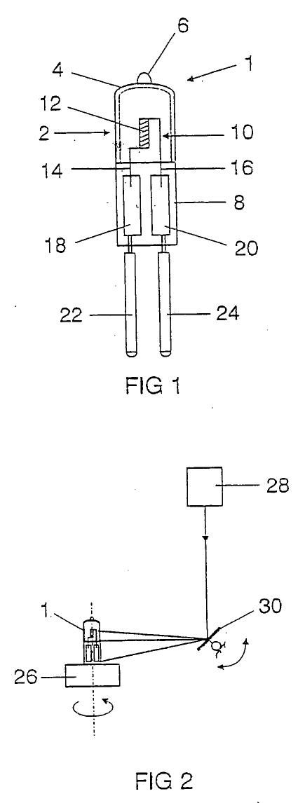

FIG. 1 illustrates an exemplary embodiment of a halogen incandescent lamp, which can be designed for low-volt operation or for the system voltage and which can be used, for example, in a living room or as a recessed furniture luminaire.

The incandescent lamp 1 has a lamp bulb 2, which, in the basic state, has approximately the shape of a hollow cylinder, an end section being formed by a dome 4, curved in the form of a ball, with an exhaust pip 6. The lamp bulb 2 is produced from quartz glass or hard glass. A pinch seal 8 is formed at the end section (at the bottom in FIG. 1) of the lamp bulb 2, which pinch seal is used to hold a frame 10 in the lamp bulb 2 in a gas-tight manner. The frame has a filament 12, whose axis runs coaxially with respect to the lamp axis (vertically in FIG. 1). The filament wire forms two power supply lines 14, 16, which are connected to molybdenum foils 18, 20, arranged in the pinch seal 8. For their part, these molybdenum foils are connected to base pins 22, 24, which are positioned outside the pinch seal 8. The pinch-sealing takes place via shaping and pinching jaws, with the result that the formerly cylindrical basic body of the lamp bulb 2 is pressed flat such that the frame 10 is fixed in position with respect to the lamp bulb 2. During manufacture, an exhaust tube is attached in the region of the exhaust pip 6, through which exhaust tube the interior of the lamp bulb 2 is evacuated and filled with filling gas. In the case of halogen lamps, this filling gas contains a halogens fraction—the halogen cycle produced during operation of the lamp has long been known and further explanations in this regard are unnecessary.

In the case in which a diffuse light is required, the lamp bulb 2 can be provided with a matt finish by means of sandblasting after filling. In particular in the case of lamp manufacturers, it is often necessary to compare the luminous flux of such lamps having a matt finish with that of lamps without a matt finish—this takes place, for example, when analyzing rival products.

According to the invention, in order to eliminate the matt finish, as illustrated in FIG. 2, the incandescent lamp 1 is arranged on a holder 26, which is mounted such that it can rotate about the vertical axis of the lamp. The surface of the lamp bulb is heated by means of a laser 28, whose laser beam is deflected, via focusing optics, by a scanner mirror 30, with the result that a specific beam profile can be set. In the exemplary embodiment illustrated, the scanner mirror 30 can be pivoted about a pivot axis arranged vertically with respect to the plane of the drawing, with the result that the laser beam can be aligned along the vertical axis of the lamp. In principle, the scanner mirror 30 can also be mounted such that it can also be deflected in the transverse direction, i.e. in the radial direction of the lamp, with the result that any desired beam profile can be set. In most solutions, however, it should be sufficient to pivot the scanner mirror 30 in the predetermined manner in the vertical direction, the advance in the transverse direction taking place by stepwise or continuous rotation of the holder 26.

The introduction of energy is now controlled such that the surface regions of the lamp bulb 2 are fused within a region predetermined by the beam profile and the rotation of the holder 26, the particulate structure of the matt finish 31 melting or evaporating and the original, clear structure of the lamp bulb being produced in the fused glass region. The luminous flux can then be determined easily. The method according to the invention makes it possible to substantially simplify the complexity for removing the matt finish in comparison with conventional solutions, in which, firstly, a very high amount of rejects occurred owing to breakage of the lamp bulbs and, secondly, a considerable amount of time of up to 30 minutes was required. With the solution according to the invention, the number of rejects is substantially reduced, the exposure time to the laser beam being in the seconds range.

In specific applications, it is desirable to provide the lamp with a faceted portion in order to bring about, for example, a light/dark effect or an anti-dazzle effect without any loss in luminous flux.

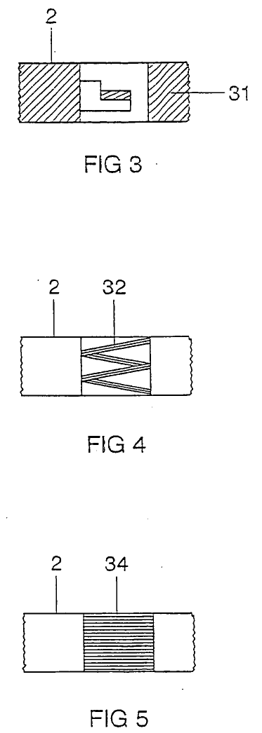

Owing to the subsequent processing according to the invention, it is possible for such a faceted portion to be applied, after filling, to the incandescent lamp 1, for example using the apparatus illustrated in FIG. 2, it being possible for a zigzag-shaped faceted portion 32 as shown in FIG. 4 or a parallel faceted portion 34 as shown in FIG. 5 to be produced by corresponding driving of the scanner mirror 30 and driving of the holder 26 and by suitable focusing of the laser spot. The zigzag-shaped faceted portion 32 shown in FIG. 4 comprises a large number of zigzag channels, which run parallel adjacent to one another. Naturally, other facet patterns can also be formed, for example wavy lines, intersecting lines or the like.

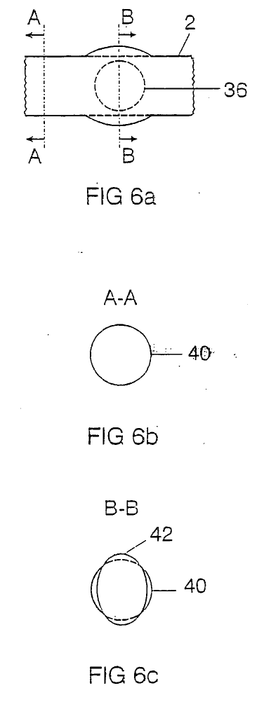

FIG. 6 illustrates a further variant of an incandescent lamp which has been processed in accordance with the method according to the invention. Here, a lamp bulb 2 of a halogen incandescent lamp is illustrated, in the case of which one or more filaments (not illustrated) is or are held by means of pimples 36, which are pressed radially into the lamp bulb 2. Such a solution has been described, for example, in DE 195 28 686 A1 and is marketed by Osram GmbH under the product name “HALOPIN”. These lamps are preferably designed for operation on the system voltage in the high-volt range.

Should such a design with pimples for holding the filament now be provided with an interference filter coating, the heat losses can be reduced further if the lamp bulb and the filament form an optical system, the heat-reflecting layer on the bulb reflecting the IR radiation back onto the filament. The procedure according to the invention now makes it possible to also provide such lamps with the IR coating (IRC). In this case, the incandescent lamp 1 is initially produced in the conventional manner, the filament(s) being fixed in position by means of the pimples. After filling and closing of the lamp bulb, the partially manufactured incandescent lamp 1 is inserted into the apparatus shown in FIG. 2, and the lamp bulb 2 is heated to its deformation temperature in the region around the filament by means of the laser 28 and then deformed by means of a suitable tool, for example a shaping roller, with the result that the round cross section 40 of the lamp bulb 2 can be expanded to a larger diameter. Another, for example elliptical, shape can be produced along the bulb axis. This subsequent deformation of the lamp body can also be applied to lamp designs in which the pimples 36 or the like are not formed, of course.

The invention discloses a method for processing a lamp and a lamp which has been processed in accordance with such a method. This lamp has a lamp bulb, in which a luminous means having power supply lines is accommodated and which delimits a space accommodating filling gas, which space is closed in a sealing manner by a pinch seal. According to the invention, after filling, part of the lamp bulb is heated by a supply of heat and deformed or remelted in order to change the outer contour of the lamp bulb.

The invention is not restricted to the exemplary embodiments explained in more detail above. For example, a lamp vessel, which consists of a glass, in particular hard glass or soft glass, and is used, for example, as the outer bulb for a halogen incandescent lamp or a high-pressure discharge lamp, can be provided with a matt finish by means of a CO₂ laser or focusing optics and the above-described scanner by part of the surface or the entire surface of the lamp vessel being roughened with the aid of the laser by means of removal—i.e. by evaporation and suction—of glass or by, in particular in the case of soft glass, the matt-finish effect being produced by producing tiny cracks which act as scattering centers.

In the case of glasses (in particular soft glass or hard glass), the reduction of mechanical stresses in the glass and the elimination of microscopically small cracks on the glass surface can take place by means of large-area heating by means of a laser. At present, the finished lamps are usually subjected to the heat treatment in a tempering furnace for the purpose of reducing mechanical stresses in the glass. One disadvantage here is the fact that, in the process, base parts or the power supply line may also be heated and oxidized. In the method according to the invention, the glass bulb can be subjected locally to a heat treatment in a targeted manner in order to reduce mechanical stresses in the glass bulb without the power supply lines and the base parts being heated in the process.

1. A method for processing a lamp (1) having a lamp bulb (2), in which a luminous means (12) having power supply lines (14, 16; 18, 20; 22, 24) is accommodated and which delimits a space accommodating filling gas, which space is closed by a pinch seal (8), characterized in that, after filling and pinch-sealing, a section of the lamp bulb (2) is heated by a supply of heat and deformed or fused or tempered.

2. The method as claimed in claim 1, the heating taking place by means of laser beams or the like.

3. The method as claimed in claim 1, the laser beam being guided along a predetermined movement path such that the section of the lamp bulb (2) is subjected to a heat treatment by means of the laser beam and the mechanical stresses in the glass are reduced there.

4. The method as claimed in claim 1, the laser beam being guided along a predetermined movement path such that a surface layer is remelted areally or a surface pattern (32, 34) is formed by means of fusing or by means of material removal.

5. The method as claimed in claim 1, the lamp bulb (2) being deformed, after being heated to a deformation temperature, by means of a tool.

6. The method as claimed in claim 1, at least part of the surface of the lamp bulb or of a vitreous lamp vessel surrounding the lamp bulb being roughened or given a matt finish by means of laser beams.

7. A lamp having a lamp bulb (2), in which a luminous means (12) having power supply lines (14, 16; 18, 20; 22, 24) is accommodated and which delimits a space for accommodating filling gas, which space is closed in a sealing manner by means of a pinch seal (8), characterized in that, after filling and pinch-sealing, a section of the lamp bulb (2) is heated by a supply of heat and deformed or remelted.

8. The lamp as claimed in claim 7, said lamp being provided with a heat-reflecting coating, and the lamp bulb (2) being deformed elliptically at least in sections, in cross section (42).

9. The lamp as claimed in claim 7, the luminous means being at least one filament (12) which is held by pimples (36) on the lamp bulb (2).

10. The lamp as claimed claim 7, the surface pattern being a faceted portion (32, 34).

11. The lamp as claimed in claim 10, the faceted portion (32, 34) running in the parallel direction or in the zigzag direction.

12. The method as claimed in claim 2, the laser beam being guided along a predetermined movement path such that the section of the lamp bulb (2) is subjected to a heat treatment by means of the laser beam and the mechanical stresses in the glass are reduced there.

13. The method as claimed in claim 2, the laser beam being guided along a predetermined movement path such that a surface layer is remelted areally or a surface pattern (32, 34) is formed by means of fusing or by means of material removal.

14. The method as claimed in claim 2, the lamp bulb (2) being deformed, after being heated to a deformation temperature, by means of a tool.

15. The method as claimed in claim 2, at least part of the surface of the lamp bulb or of a vitreous lamp vessel surrounding the lamp bulb being roughened or given a matt finish by means of laser beams.

16. The lamp as claimed in claim 8, the luminous means being at least one filament (12) which is held by pimples (36) on the lamp bulb (2).

17. The lamp as claimed in claim 8, the surface pattern being a faceted portion (32, 34).

18. The lamp as claimed in claim 9, the surface pattern being a faceted portion (32, 34).
